(19) United States
(12) Patent Application Publication
(10) Pub. No.: US 2010/0295298 A1
(43) Pub. Date: Nov. 25, 2010

(54) DEVICE FOR PRE-STRESSED SEALED CONNECTION WITH FLANGES

(75) Inventors: Isabelle Haumont, Notre Dame de l'Lsle (FR); Christian Roure, Vernon (FR)

Correspondence Address: WEINGARTEN, SCHURGIN, GAGNEBIN & LEBOVICI LLP, TEN POST OFFICE SQUARE, BOSTON, MA, 02109, US

(73) Assignee: SNECMA, Paris (FR)

(21) Appl. No.: 12/594,444

(22) PCT Filed: Apr. 4, 2008
(86) PCT No.: PCT/FR08/50602

§ 371 Date: Jan. 28, 2010

(30) Foreign Application Priority Data
Apr. 5, 2007 (FR) 0754313

(51) Int. Cl. F16L 23/18; F16L 23/00

(52) U.S. Cl. 285/412; 285/406

(57) ABSTRACT

The prestressed flanged leaktight connection device comprises a first flange (130) presenting a first contact surface (111), a second flange (140) presenting a second contact surface (121) situated facing the first contact surface (111), a sealing gasket (160) received in a gasket housing (170) formed between the first and second contact surfaces and clamping elements (150) for clamping together the first and second flanges (130, 140). The first and second contact surfaces present a localized bearing zone (Z1) forming a dog situated in the vicinity of the sealing gasket (160). At least one (111) of the first and second contact surfaces presents, in the localized bearing zone (Z1) a surface of specified shape, e.g. conical, such that before tightening of the tightening elements (150), contact between the first and second flanges (130, 140) at the localized bearing zone (Z1) is limited to a fraction of the surface of the localized bearing zone (Z1), whereas after tightening of the tightening elements (150; 250) the contact is distributed evenly over all of the localized bearing zone (Z1).

### FIELD OF THE INVENTION

The present invention relates to a prestressed flanged leaktight connection device comprising a first flange presenting a first contact surface, a second flange presenting a second contact surface situated facing said first contact surface, a sealing gasket received in a gasket housing formed between said first and second contact surfaces, and clamping means for clamping together the first and second flanges, the clamping means being disposed between the gasket housing and the peripheries of the first and second flanges so as to put into mutual contact at least portions of the first and second contact surfaces between the flanges.

The invention thus applies to connections that can be taken apart.

### PRIOR ART

The invention relates to “dog-clamp” flanged connections in which there exists a narrow contact surface between the flanges so as to obtain high contact pressure close to the gasket, thereby increasing sealing performance while minimizing deformation of the gasket housing.

FIG. 8 is an axial half-section view showing an example of a known flanged connection device having an axis of symmetry 1, two pipework elements 10, 20 provided with respective flanges 30, 40 of the dog-clamp type that are assembled to each other with the help of connection members 50 such as bolts. The flanges 30, 40 include a contact dog 11, 21 situated on the inside relative to a gasket 60 placed in a gasket housing 70. The other surfaces 31, 32, and 41, 42 of the flanges 30 and 40 respectively placed facing each other in register with the bolts 50, do not come into contact before the bolts 50 have been tightened, and an empty space of small thickness is left between these facing surfaces.

In operation, after the bolts 50 have been tightened and in the presence of a pressure field P inside the pipework 10, 20, the empty space between the surfaces 31, 32 of the flange 30 and the surfaces 41, 42 of the flange 40 diminishes and enables the dog 11 of the flange 30 to remain in contact with the corresponding surface 21 of the flange 40.

In similar manner, FIG. 9 is an axial half-section view showing an example of a known flanged connection device similar to that of FIG. 8, but having flanges 30, 40 presenting a contact dog 31a, 41a situated on the outside relative to the gasket 60 placed in the gasket housing 70. The other surfaces 11a, 32a of the flange 30 and 21a, 42a of the flange 40 placed facing each other firstly on the inside of the gasket 60 (surfaces 11a, 21a) and secondly on the outside of the connection means (surfaces 32a, 42a) are not in contact before the bolts 50 are tightened and they define an empty space of small thickness that reduces when the bolts 50 are tightened so as to enable the surfaces 31a, 41a situated on the dog of the flange to remain mutually in contact.

Nevertheless, when designing such “dog-clamp” connections, it often happens that the contact stresses between the connections and the bearing surfaces become too great, locally. Mechanical margins then become negative.

This comes from the fact that the design of dog-clamp flanges leads to the flanges bending.

A consequence of this bending is to focus contact on the dogs onto the peripheries thereof, thereby concentrating forces, and thus concentrating compression stresses.

A direct consequence of this effect is to plastically deform contacting surfaces during assembly and when in operation, to the detriment of the quality of those surfaces.

A consequence of such plastic deformation of the surfaces is a loosening of the connections while in service.

The conventional design response for countering such phenomena of plastic deformation and creep is to overdimension the flanges.

In order to lower excessive local stresses, it is common practice to increase the areas of the contacting surfaces, and also the thickness of the flanges, so as to decrease bending, to the detriment of weight and size.

### OBJECT AND BRIEF SUMMARY OF THE INVENTION

The invention seeks to remedy the above-mentioned drawbacks and to enable a prestressed flanged leaktight connection device to be made that presents improved quality and lifetime while its cost and size are reduced.

According to the invention, these objects are achieved by a prestressed flanged leaktight connection device comprising a first flange presenting a first contact surface, a second flange presenting a second contact surface situated facing said first contact surface, a sealing gasket received in a gasket housing formed between said first and second contact surfaces, and clamping means for clamping together the first and second flanges, the clamping means being placed between the gasket housing and the peripheries of the first and second flanges so as to put at least portions of the first and second contact surfaces into mutual contact, the device being characterized in that the first and second contact surfaces present a localized bearing zone defining a narrow contact surface between the flanges situated in the vicinity of the sealing gasket and constituting a shoulder forming a dog relative to the combination of the other zones of the first and second contact surfaces, in that at least one of the first and second contact surfaces presents in said localized bearing zone a surface of specified shape that is essentially conical, such that before tightening of the tightening means, contact between the first and second flanges in the localized bearing zone is limited to a fraction of the surface of the localized bearing zone, whereas after tightening of the tightening means the contact is distributed evenly over all of the localized bearing zone.

In an advantageous embodiment, the surface of specified shape that makes it possible, after tightening of the tightening means, for the contact pressure of the facing surfaces to be made uniform is thus a conical surface, which constitutes an “industrial” solution close to the ideal surface.

Preferably, said fraction of the surface of the localized bearing zone corresponds to a value that is less than or equal to 30% of the surface of the localized bearing zone.

The localized bearing zone may constitute a dog that is on the inside or a dog that is on the outside relative to the sealing gasket.

In a particular embodiment, the device includes a spacer that is interposed between the first and second flanges in said shaped bearing zone and presenting a surface of specified shape constituting said surface of specified shape defining the contact between the first and second flanges in the localized bearing zone.

By means of measures recommended by the present invention, it is not necessary to reinforce or enlarge the portions constituting the connection device and it is only the geometrical shape of the surfaces in contact at the localized bearing zone that enables the maximum stress level to be reduced and optimized at the contact between a dog formed on a flange and the corresponding bearing face formed on the other flange.

When machining a surface that is conical, it is possible to optimize the flanged connection device with a dog-clamp in such a manner that the contact at the dog i.e. in the localized bearing zone, becomes almost perfect after the applying of the clamping force and the deformation of the connection that results therefrom. As a result, contrary to prior art devices, local force concentrations and mechanical stress concentrations are eliminated.

By improving stress distribution in this way over the entire contact surface of the localized bearing zone, it is possible to make the contact surfaces smaller, which enables the overall size of the connection to be made smaller, and for the dog flange on the inside of the gasket, the reduction in the width of the dog also enables the diameter of the gasket to be reduced, and thus to minimize the root effect. This reduction in the root effect makes it possible to reduce the need for tightening and consequently the number of screws.

This invention also makes it possible to reduce the thickness of the flanges because the deformation of the flanges is no longer as problematic.

By eliminating the concentration of stress, the invention makes it possible to limit the loss when in operation of the tightness of connections due to plastic deformation and thus improves leaktightness.

The invention also makes it possible to avoid the degradation of surfaces and to increase the lifetime of the assembly.

To summarize, the invention makes it possible to achieve savings in weight, and increases in mechanical margins and in leaktightness.

### BRIEF DESCRIPTION OF THE DRAWINGS

Other characteristics and advantages of the invention appear from the following description of particular embodiments, given with reference to the accompanying drawings, in which:

FIGS. 1 and 2 are axial half-section views of a first example of a prestressed flanged leaktight connection device of the invention, respectively before and after tightening the bolts that provide prestress;

FIGS. 3 and 4 are axial half-section views of a second example of a prestressed flanged leaktight connection device of the invention, respectively before and after tightening the bolts that provide prestress;

FIG. 5 is an axial half-section view showing the application of a leaktight connection device of the invention to a tank of fluid under pressure;

FIG. 6 is a detailed view of the leaktight connection device of FIG. 5;

FIG. 7 is an axial section view of a spacer that is suitable for being implemented in a leaktight connection device such as is shown in FIGS. 4 and 5; and

FIGS. 8 and 9 are axial half-section views of two examples of a known flanged leaktight connection device of the dog-clamp type, respectively in a configuration with a dog situated on the inside relative to the sealing gasket and in a configuration with a dog situated on the outside relative to the sealing gasket.

### DETAILED DESCRIPTION OF PARTICULAR EMBODIMENTS

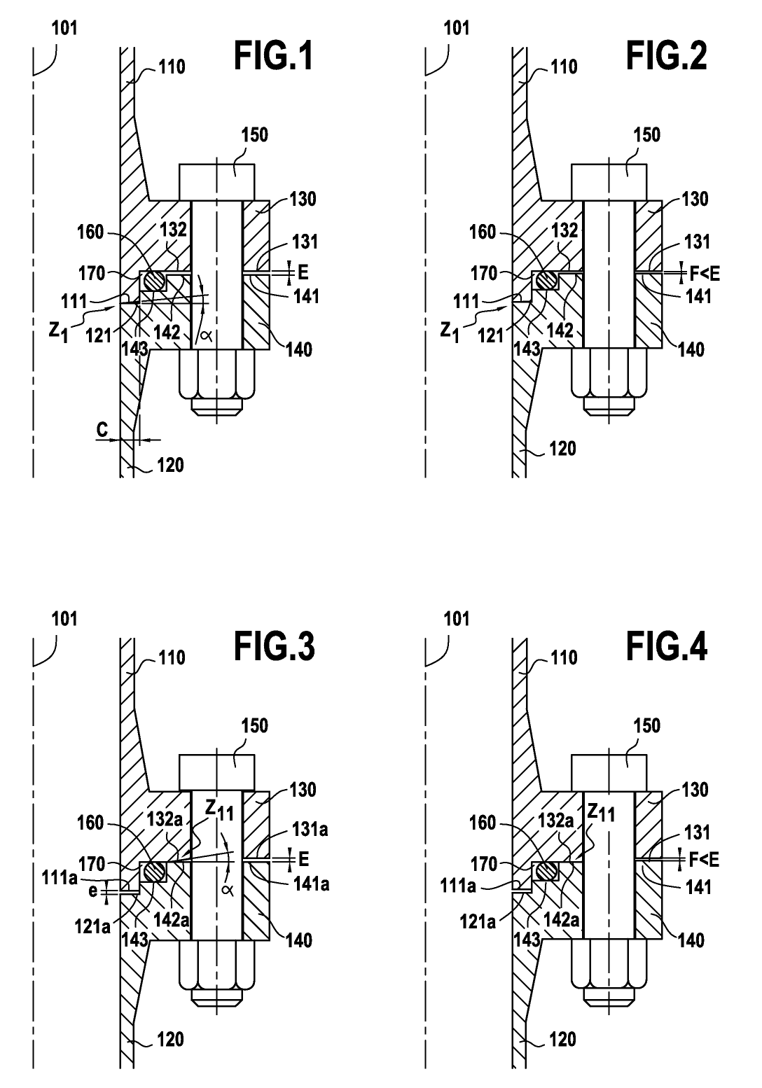

A first embodiment of a releasable prestressed flanged leaktight connection device in accordance with the invention is described with reference to FIGS. 1 and 2.

In this example, pipework or tank segments 110, 120 about an axis of revolution 101 are connected to respective annular flanges 130 and 140. The flanges 130 and 140 have connection elements 150 such as bolts, screws, studs, or the like passing through them and serving to exert prestress on the flanges 130 and 140.

FIG. 1 shows a connection device prior to tightening the connection elements 150 while FIG. 2 shows the connection device after said connection elements 150 have been tightened.

In FIG. 1, in the vicinity of the connection elements 150, the bottom face 131, 132 of the top flange 130, which face extends essentially transversely relative to the axis of rotation 101, is a continuous surface without any set-back portion (apart from the openings for passing the connection elements 150).

The bottom face 131, 132 of the top flange 130 is connected on the inside to a portion of the pipework segment 110 having a bottom face 111 that, prior to tightening the bolts 150 (FIG. 1), forms in a localized zone Z1 an angle α relative to a direction that is perpendicular to the axis 101.

The top face 141, 142 of the bottom flange 140 presents a continuous surface extending essentially transversely relative to the axis of revolution 101 in the vicinity of the connection elements 150. Prior to tightening of the bolts 150, the face 141, 142 of the flange 140 is spaced a little from the face 131, 132 of the flange 130, by a distance E.

The top face 141, 142 of the flange 140 nevertheless presents a set-back portion 143 for co-operating with a portion of the face 132 of the flange 130 and the pipework segment 110 to form a housing 170 in which a gasket 160 is placed.

The set-back portion 143 is extended by a shoulder and inwardly defines in the zone Z1 a surface 121 that, before the bolts 150 have been tightened, forms an angle α with the facing surface that is conical 111 and is therefore only in contact with the surface 111 over a fraction of the surface of the localized bearing zone Z1, which extends over a distance C (FIG. 1).

In a first possible embodiment, the surface 121 is perpendicular to the axis 101, and the surface 111 is a surface that is conical. In another possible embodiment, the surface 111 is perpendicular to the axis 101, and the surface 121 is a surface that is conical.

After the bolts have been tightened 150, as can be seen in FIG. 2, the distance F between the bottom face 131, 132 of the top flange 130 and the top face 141, 142 of the bottom flange 140 is reduced to a value that is less than that of the initial distance E.

At the dog of the flange 130, which corresponds to the localized bearing zone Z1, it can be seen that the bottom surface 111 of the channel segment 110 is in uniform contact with the face 121 of the channel segment 120. After the bolts 150 have been tightened, the contact is therefore evenly distributed over the whole of the localized bearing zone Z1, which in the embodiment in FIGS. 1 and 2 is situated at a dog that is on the inside relative to the point 160.

It should be observed that the terms “bottom” and “top” are used in the present description for convenience when referring to the position of the flanges in the drawings, but the flanged connection can naturally have any position relative to the vertical.

In the invention, on a dog flange connection it is possible to obtain a dog/flange contact (in the zone Z1) that is almost perfect, even though the connection becomes deformed by the clamping force.

In this event, the local concentrations of forces and concentrations of mechanical stresses are non-existent. The contact pressure can thus be compared to an average pressure, that is easy to calculate, and that depends only on the force and on the area of the contact surface.

At the start of assembly, and as a result of the slope of the face 111 relative to the face 121, when the clamping force has not yet been applied, the flange/dog contact surfaces (in the zone Z1) have little contact area because the components are not deformed.

Given the deformation of components of the assembly, the load-carrying capacity in the localized bearing zone Z1 increases with an increase in the clamping force. The deformation of the parts is calculated so that the contact area in the zone Z1 ends up as a maximum once the clamping force is fully applied (FIG. 2).

The invention thus makes it possible to conserve all the advantages of “dog-clamp” flanged connections, i.e. the existence of a narrow contact surface between the flanges in a localized bearing zone Z1 situated in the vicinity of the sealing gasket and constituting a shoulder relative to all of the other zones of the contact surface, so as to obtain a high contact pressure close to the gasket, and thus increase the leaktightness by minimizing the deformation of the gasket housing, without having the drawbacks of the prior art (degradation of the state of the contacting surfaces during assembly or in operation as a result of an excessive concentration of forces or as a result of the need to increase the contacting surfaces and the thickness of the flanges, so as to decrease bending, to the detriment of weight and size).

In the invention, it is the deformation of the components that contributes to the good distribution of contact stresses, as a result of the initial shape of the facing surfaces in the localized bearing zone Z1.

The definition of the angle α and of the area of the initial contact between the surface 111 and 121 is optimized by using finite element calculations so that contact between the components is perfect when the parts become deformed by tightening. The angle α may preferably lie in the range 1° and 10°.

At the end of tightening, the contact pressure can be compared to an average pressure, that depends only on the force and the area of the contact surface, and that is therefore easy to calculate.

The characteristics of the surfaces 111 and 124 can be obtained by modeling a number of distinct conical envelope surfaces for the dogs, in association with an iterative or parametric approach that also takes account of the clamping force of the screws.

The initial optimum shape to be used may be deduced by analyzing the contact pressure fields obtained from the various calculations.

By way of example, for an application to a connection between a hot gas generator and a turbine input line of a stationary engine, a connection has been made that includes a first dog in the configuration shown in FIGS. 1 and 2.

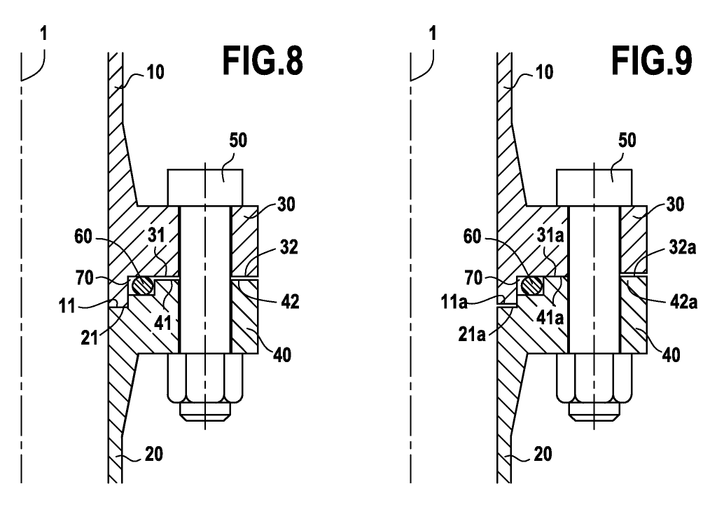

In this example, for a flange made out of Inconel 625, the plastic deformation stress of the dog exceeds the elastic limit of the material (elastic limit of 360 mega pascals (MPa)) over about one third of the dog for a conventional dog, such as the dog shown in FIG. 8. In contrast, by conically machining the dog, as in FIG. 1, an almost uniform distribution of stresses is observed and a maximum plastic deformation stress (of 340 MPa) that is below the elastic limit.

Concerning the maximum local stresses in the example given above, conical machining of the dog (surface 111) also presents a positive effect insofar as the maximum stresses go from 581 MPa to 340 MPa.

The optimization provided by the invention increases the mechanical margins of the connections, thereby making it possible to reduce weight, said optimization being obtained without any extra production cost since the conical surfaces can be made using conventional turning techniques.

FIGS. 3 and 4 show a variant embodiment of the invention, which is applied to dog-clamp flanged connections of the type in which the dog, and therefore the localized bearing zone Z11, are situated outside the gasket 160.

In FIGS. 3 and 4, the elements that are similar to those shown in FIGS. 1 and 2 are given the same references. Thus two channel segments 110, 120 can be seen that are equipped with flanges 130, 140 assembled by connection elements 150, leaktightness being assured by a gasket 160 placed in a housing 170.

In FIG. 3, which corresponds to a situation before the bolts 150 have been tightened, the portions 111a, 132a, 131a of the bottom face of the top flange 130 correspond to the portions 111, 132, 131 of the bottom face of the flange 130 of FIG. 1 and the portions 121a, 143, 142a, 141a of the top face of the bottom flange 140 correspond to the portions 121, 143, 142, 141 of the top face of the flange 140 of FIG. 1.

However, in the embodiment shown in FIG. 3, the faces 111a and 121a of the channel segments 110, 120 that are situated inside relative to the gasket 160 are both perpendicular to the axis 101 and mutually define an empty space of thickness e.

In contrast, in the embodiment shown in FIG. 3, the localized bearing zone Z11 is situated level with the surfaces 132a, 142a that are inserted between the gasket housing 170 and the connection elements 150. The surface 132a is conical and forms an angle α, which preferably lies in the range 1° and 10°, relative to the surface 142a of the flange 140 that is perpendicular to the axis 101. Before the bolts 150 have been tightened, the conical surface 132a is only in contact with the surface 142a of the localized bearing zone Z11 over a fraction of the surface of the zone Z11. For FIG. 3, the bottom surface 131a of the top flange 130 and the top surface 141a of the bottom flange 140, which are situated outside of the connection elements 150, present a gap of a thickness E. The surface 131a may optionally be a continuation of the conical surface 132a.

After the bolts 150 have been tightened (FIG. 4), the distance between the bottom face 131a of the top flange 130 and the top face 141a of the bottom flange 140 presents a value F that is less than the value E of the initial distance of FIG. 3.

In the localized bearing zone Z11, after the bolts 150 have been tightened, the bottom surface 132a of the top flange 130 is in uniform contact with the top surface 142a of the bottom flange 140. The contact is therefore evenly distributed over the whole of the localized bearing zone Z11, which in the embodiment in FIGS. 3 and 4 is situated at the outer dog relative to the gasket 160.

For the embodiment in FIGS. 3 and 4, as in the embodiment in FIGS. 1 and 2, the definition of the angle α and of the area of the initial contact between the surfaces 132a, 142a is optimized by using finite element calculations so that the contact of the components is optimized when the parts become deformed by tightening.

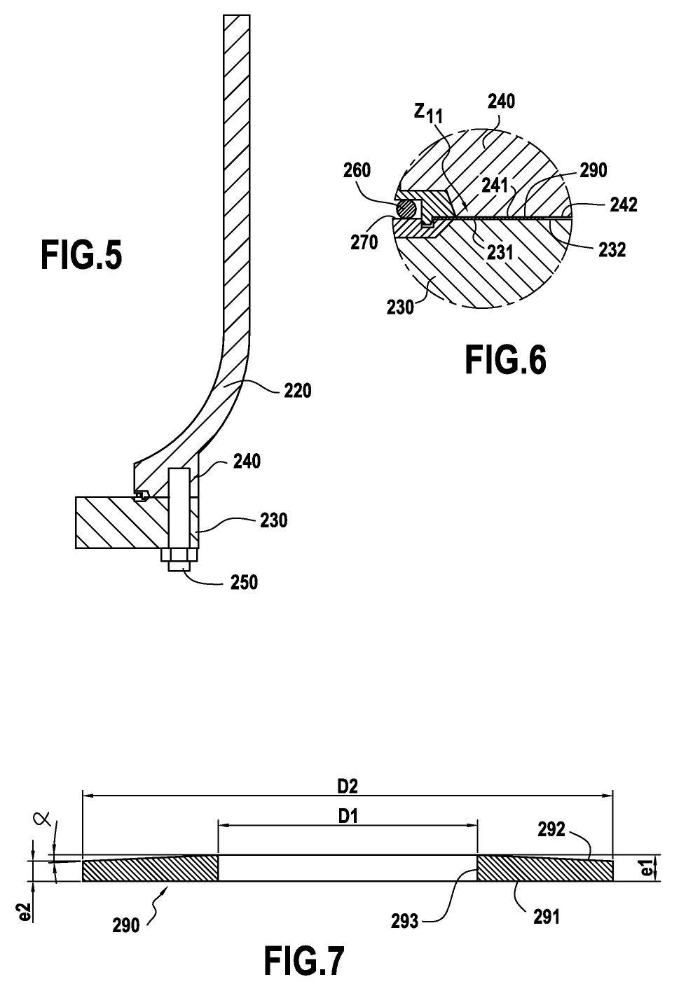

FIGS. 5 and 6 show an example of the invention applied to a flanged connection between the wall 220 of a reservoir that is suitable for containing a fluid such as hydrogen, and the cover 230 thereof. In this situation, and as can be seen in FIG. 5, the reservoir 220 includes a flange 240 that co-operates with the peripheral portion of the cover 230 and that is assembled thereto by studs 250.

FIG. 6 shows in more detail the portions of the flange 240 and of the cover 230 that co-operate mutually in the vicinity of the gasket 260 placed in a housing 270. The wall 242 of the flange 240 faces the wall 232 of the cover 230 with an empty space of small thickness, whereas the localized bearing zone Z11 that is situated just outside the gasket 260 is defined by the surfaces 241, 231 facing the flange 240 and the cover 230.

However, unlike in FIGS. 3 and 4, the mutual co-operation between surfaces 241 and 231 is not direct, and they can therefore be parallel and not divergent. In the embodiment shown in FIGS. 5 and 6, a spacer 290 is inserted between the surface 231 and 241 defining the localized bearing zone Z11.

As can be seen in FIG. 7, the spacer 290 includes a plane face 291 for co-operating with one of the faces 231, 241 and a conical face 292 for co-operating with the other one of the faces 231, 241.

The conical face 292 slopes at an angle α relative to the plane face 291.

As shown in FIG. 7, the annular spacer 290 presents an outside diameter D2, an inside diameter D1 (orifice 293), a thickness e₁ at the inner portion of the inside diameter D1 and a thickness e₂, less than e₁, at the outer portion of the outside diameter D2.

The conical surface 292 of the spacer 290 has the same role as the conical surface 132a of FIG. 3 or the conical surface 111 of FIG. 1.

The conical machining of the spacer makes it possible to resolve the problems of plastic deformation of the spacer and of the bearing surfaces that would appear if the flat spacer was of uniform thickness.

By way of example, for a spacer 290 made of a stainless steel such as 304L stainless steel, the elastic limit is 180 MPa. The spacer can be dimensioned to 150 MPa (for a clamping force corresponding to 91 tons per stud 250).

With a flat spacer of uniform thickness (dimensioned as indicated above e.g. e=14 millimeters (mm), D₁=542 mm, D₂=646 mm) whether during assembly or in operation, the stress field is concentrated in the immediate vicinity of the outer peripheral portion of the spacer, and during assembly reaches values that are generally greater than the elastic limit of 180 MPa. These stresses are mainly due to the deformation of the cover under the effect of tightening and to the edge effect.

In the same way, if the reservoir is made out of A48H alloy with an elastic limit of 255 MPa, it should be observed that the implementation of a spacer 290 of constant thickness e induces a compression stress that can reach 285 MPa on the part of the flange of the reservoir in contact with the spacer.

Conversely, with a “shaped” spacer 290 constituting FIG. 7, e.g. with a thickness e_{z}=1.25 mm at the outer periphery of the spacer of and a thickness e₁=1.4 mm at the internal opening 293, it should be observed that the distribution of stress is balanced.

In addition, with a shaped spacer 290, the distribution of stress is also more uniform of the faces of the reservoir that is in contact with the spacer, and that makes it possible to reduce the stress and avoid the surfaces being marked. The maximum plastic deformation stress of 285 MPa in the above-described example may thus be reduced to 120 MPa.

The invention also applies to “two-dog” flanged connections that include an additional dog that is reduced in size and that acts in addition to the co-operation between the surfaces 131, 141 (FIGS. 1 and 2) or the surface 131a, 141a (FIGS. 3 and 4), in a zone that is spaced apart from the gasket 160 and that is situated on the other side of the tightening means relative to the first main dog.

1. A prestressed flanged leaktight connection device, the device comprising a first flange presenting a first contact surface, a second flange presenting a second contact surface situated facing said first contact surface, a sealing gasket received in a gasket housing formed between said first and second contact surfaces, and clamping means for clamping together the first and second flanges the clamping means being placed between the gasket housing and the peripheries of the first and second flanges so as to put at least portions of the first and second contact surfaces into mutual contact;
the device being characterized in that the first and second contact surfaces present a localized bearing zone defining a narrow contact surface between the flanges, situated in the vicinity of the sealing gasket and constituting a shoulder forming a dog relative to the combination of the other zones of the first and second contact surfaces, in that at least one of the first and second contact surfaces presents in said localized bearing zone a surface of specified shape that is essentially conical, such that before tightening of the tightening means, contact between the first and second flanges in the localized bearing zone is limited to a fraction of the surface of the localized bearing zone, whereas after tightening of the tightening means the contact is distributed evenly over all of the localized bearing zone.

2. A device according to claim 1, characterized in that said fraction of the surface of the localized bearing zone corresponds to a value that is less than or equal to 30% of the surface of the localized bearing zone.

3. A device according to claim 1, characterized in that said localized bearing zone constitutes a dog on the inside relative to the sealing gasket.

4. A device according to claim 1, characterized in that said localized bearing zone constitutes a dog on the outside relative to the sealing gasket.

5. A device according to claim 1, characterized in that it includes a spacer that is interposed between the first and second flanges in said localized bearing zone and that presents a surface of specified shape constituting said surface of specified shape defining the contact between the first and second flanges in the localized bearing zone.

6. A device according to claim 1, characterized in that the tightening means comprise a combination of fastener elements disposed perpendicularly to the first and second flanges.

7. A device according to claim 1, characterized in that it applies to pipework or an enclosure containing a fluid under pressure.

8. A device according to claim 1, characterized in that:
said localized bearing zone constitutes a dog on the inside relative to the sealing gasket;
said localized bearing zone constitutes a dog on the outside relative to the sealing gasket;
it includes a spacer that is interposed between the first and second flanges in said localized bearing zone and that presents a surface of specified shape constituting said surface of specified shape defining the contact between the first and second flanges in the localized bearing zone;
the tightening means comprise a combination of fastener elements disposed perpendicularly to the first and second flanges; and
it applies to pipework or an enclosure containing a fluid under pressure.

9. A device according to claim 1, characterized in that:
said localized bearing zone constitutes a dog on the outside relative to the sealing gasket;
it includes a spacer that is interposed between the first and second flanges in said localized bearing zone and that presents a surface of specified shape constituting said surface of specified shape defining the contact between the first and second flanges in the localized bearing zone;
the tightening means comprise a combination of fastener elements disposed perpendicularly to the first and second flanges; and
it applies to pipework or an enclosure containing a fluid under pressure.

10. A device according to claim 2, characterized in that it includes a spacer that is interposed between the first and second flanges in said localized bearing zone and that presents a surface of specified shape constituting said surface of specified shape defining the contact between the first and second flanges in the localized bearing zone.

11. A device according to claim 2, characterized in that the tightening means comprise a combination of fastener elements disposed perpendicularly to the first and second flanges.

12. A device according to claim 2, characterized in that it applies to pipework or an enclosure containing a fluid under pressure.

13. A device according to claim 3, characterized in that:
it includes a spacer that is interposed between the first and second flanges in said localized bearing zone and that presents a surface of specified shape constituting said surface of specified shape defining the contact between the first and second flanges in the localized bearing zone;
the tightening means comprise a combination of fastener elements disposed perpendicularly to the first and second flanges; and
it applies to pipework or an enclosure containing a fluid under pressure.

14. A device according to claim 4, characterized in that:
it includes a spacer that is interposed between the first and second flanges in said localized bearing zone and that presents a surface of specified shape constituting said surface of specified shape defining the contact between the first and second flanges in the localized bearing zone;
the tightening means comprise a combination of fastener elements disposed perpendicularly to the first and second flanges; and
it applies to pipework or an enclosure containing a fluid under pressure.
